(19) United States
(12) Patent Application Publication
(10) Pub. No.: US 2006/0150337 A1
(43) Pub. Date: Jul. 13, 2006

(54) Novel bed seat

(76) Inventor: Edwin Torres, New York, NY (US)

Correspondence Address: JONES DAY, 222 EAST 41ST ST, NEW YORK, NY, 10017, US

(21) Appl. No.: 11/329,730

(22) Filed: Jan. 10, 2006

Related U.S. Application Data
(60) Provisional application No. 60/642,680, filed on Jan. 10, 2005.

(51) Int. Cl. A47C 20/02; A61G 13/12

(52) U.S. Cl. 5/648; 5/624

(57) ABSTRACT

A support system for use with a hospital bed, reclining seats, infant or baby seats and the like in the form of a pillow or other comfortable support piece having a pair of openings for the legs or thighs of a user is disclosed. A preferred support system allows maintaining the legs of the user at an approximately right angles to the user's torso.

### CROSS-REFERENCE TO RELATED PATENT APPLICATIONS

This application claims priority to the provisional patent application identified by its Ser. No. 60/642,680 filed on Jan. 10, 2005, which provisional patent application is incorporated herein by reference.

### FIELD OF THE INVENTION

The present invention is directed to the field of adjustable beds, hospital beds, reclining beds including adjustable bed seats. In particular, the present invention relates to methods and components for modifying an inclinable bed, for instance, a hospital bed, such that a patient may rest comfortably with a reduced risk of collection of bodily fluids.

### BACKGROUND OF THE INVENTION

Confinement for a significant time to a hospital bed may present a distinct and independent cause of additional complications for a patient. These problems are typically in addition to the original illness or condition requiring confinement to the hospital bed. Laying flat causes muscles to atrophy and bodily fluids to collect. It is particularly important for patients with back of knee surgery to sit comfortably with their legs in an upward position, while they eat.

There have been a number of patents directed to the area of bed seats and improved bed seats suitable for propping up a patient. U.S. Pat. No. 5,398,357 is directed towards a hospital bed that may be converted into a chair configuration and with a serially hinged normally horizontal head panel, seat panel thigh panel and a foot panel. The foot panel has a central section and a wing section longitudinally pivoted on each lateral side of the central section. To convert the horizontal bed to the chair configuration the head panel is pivoted upwardly and the front panel pivots downwardly between parallel rail members of the bed frame. The hinged intersection of the foot panel and the thigh panel pivots upwardly to support the patient's knees. Through sliding contact with rail members of the bed frame each wing section pivots upwardly in response to the downward movement of the central section of the foot panel. With the foot end of the foot panel pivoted downwardly between the rails of the bed frame and the head end of the foot panel pivoted upwardly to support the patient's knees and the head panel pivoted upwardly to support the patient's knees and the head panel pivoted upwardly to support the patient's back, the hospital bed is converted to a chair configuration.

U.S. Pat. No. 4,628,551 is directed towards a body support applicable to a hospital bed, seat or the like includes a substantially horizontal frame on which a series of carriers are mounted for oscillation about parallel axes transverse of the frame, substantially rectangular-section support blocks of resiliently yieldable material being mounted on the carriers, drive means being provided for oscillating the carriers and the support blocks mounted thereon in unison to tilt the upper faces of the support blocks alternately in both directions from horizontal, varying the pressure applied by all parts of a body supported by the support blocks.

U.S. Pat. No. 4,131,960 is directed towards a convertible seat-bed is provided in which seat and back cushions are attached to frames which are supported from a linkage for movement between a seating condition in which the back cushion extends upwardly and rearwardly from the rear edge of the seat cushion and a bed condition in which body-engaging surfaces of the cushions are in a common horizontal plane. The linkage includes a front swing arm pivotally connected at its uppoer end to a back frame, a rear swing arm connected at its upper end and to a back frame through a short link and a link between the swing arms extending forwardly to the lower end of another link which is pivotally connected at its upper end to a seat frame and which is connected through a further link to the front swing arm. The linkage operates to keep the rear edge of the seat cushion in close proximity to an adjacent edge of the back cushion in both conditions and is located below and behind the seat and back cushions. The front of the seat cushion may be lifted for access to storage space and also to facilitate operation between the seating and bed conditions.

It is an object of this invention to provide a support pad which permits patients to sit at a ninety-degree angle.

It is a further object of this invention to provide a back and leg support which enables patients to maintain their backs approximately at right angles with respect to their lower body.

It is a further object of this invention to provide a hospital bed leg support which facilitates a bed pan.

It is a further object of this invention to provide a hospital bed leg support which can assist in natural body functions.

### SUMMARY OF THE INVENTION

A support system for use with a hospital bed: a support having a pair of openings for the legs of a patient; means affixed to the bed for propping up the support as to maintain the legs of the patient at approximately right angles with respect to the patient's upper torso. The support may have one or more features selected from a cushion, a shape contoured to complement a human body, and an opening for receiving waste.

A support system for use with a hospital bed in assisting a patient's natural functions comprising: a substantially flat support having a pair of openings for the legs of a patient and further having central aperture to facilitate a patient's natural functions; pivotable means affixed to the sides of the substantially flat support for permitting the flat support to pivot so that the patient's legs may be retained at about right angles to the upper torso to approximate a sitting position. The substantially flat support in the support system may have a central aperture to channel away waste products.

Another preferred embodiment of the invention comprises an E-shaped support affixable to a bed with a substantially rigid backing for providing support to one or more legs of a patient in the bed. Preferably, the E-shaped support is deployed to prevent the patient from sliding. The E-shaped support of claim may deployed with an additional support to grip at least one leg of the patient or a restraint such as a five point harness.

Further, the E-shaped support may be deployed with a bed panel such that the bed panel may be pivoted to place a patient in a sitting position without unacceptable sliding. In addition, the E-shaped support is affixed to allow it to pivot about at least one axis.

In another aspect, the E-shaped support may further comprising an adjustable depth for at least one of the slots in the E-shaped support.

The E-shaped support may be deployed in one or more of the set consisting of a hospital bed, an infant seat, and a reclining seat, a seat with an adjustable back such that the back may be fixed in a plurality of positions relative a horizontal portion of the seat with an adjustable back.

The invention also encompasses a method of preventing a patient in a bed from sliding by providing a support with a plurality of slots to receive at least one leg of a patient. The support with the plurality of slots preferably prevents the patient from sliding sideways or forward. Preferably, the support with the plurality of slots prevents accumulation of fluids in a leg of the patient by raising them comfortably. Moreover, advantageously a leg of the patient is supported by placing a thigh of the patient in a slot from the plurality of slots and at about right angles to a torso of the patient. This is, however, not a requirement for using the support or the claimed method. Preferably, at least one of slots does not encircle at least one leg of the patient, which makes it easy to place or remove the leg from the slot. Furthermore, the method comprises providing an adjustable depth for at least one of the plurality of slots to accommodate patients of different sizes and with different needs.

An optional opening in the support with a plurality of slots can be provided to receive waste products produced by the patient.

Preferably, the support with a plurality of slots is deployed in one or more of the set consisting of a hospital bed, an infant seat, and a reclining seat, a seat with an adjustable back such that the back may be fixed in a plurality of positions relative a horizontal portion of the seat with an adjustable back.

The invention will now be described further with reference to the following illustrative figures.

### BRIEF DESCRIPTION OF THE FIGURES

FIG. 1 is an elevational view of an embodiment of the invention.

FIG. 2 is an side view of an embodiment having a support mechanism in accordance with the present invention.

FIG. 3 is an front perspective view of an embodiment showing the support mechanism in accordance with the present invention.

FIG. 4 is an overhead perspective view of an embodiment showing the support mechanism in accordance with the present invention.

FIG. 5 is an rear perspective view of an embodiment showing the support mechanism in accordance with the present invention.

FIG. 6 is an elevational view of a schematic of an alternative embodiment showing the support mechanism suitable for assisting with the natural functions of the patient in accordance with the present invention.

FIG. 7 is an overhead view of a schematic of an embodiment showing the support mechanism suitable for assisting with the natural functions of the patient in accordance with the present invention.

FIG. 8 is an illustrative schematic of an embodiment showing the placement of hinges/connectors and the legs in slots formed in a support according to the invention.

FIG. 9 is an illustrative schematic of an embodiment showing a side view of a possible arrangement for forming slots.

FIG. 10A is an illustrative schematic of an embodiment showing a possible construction of the support having a plurality of slots according to the invention. FIG. 10A shows a top part, FIG. 10B shows a bottom part of the support and FIG. 10C shows a cross section through a rod made as a composite to provide it with strength while keeping its weight and costs low.

FIG. 11 is an illustrative schematic of an embodiment showing a possible method for making each slot depth adjustable. It should be noted that similar adjustments can be made to increase or decrease the width of one or more slots.

### DESCRIPTION OF THE PREFERRED EMBODIMENTS

A preferred embodiment of the present invention is described with reference to the accompanying illustrative Figures wherein the same numbers are used where applicable.

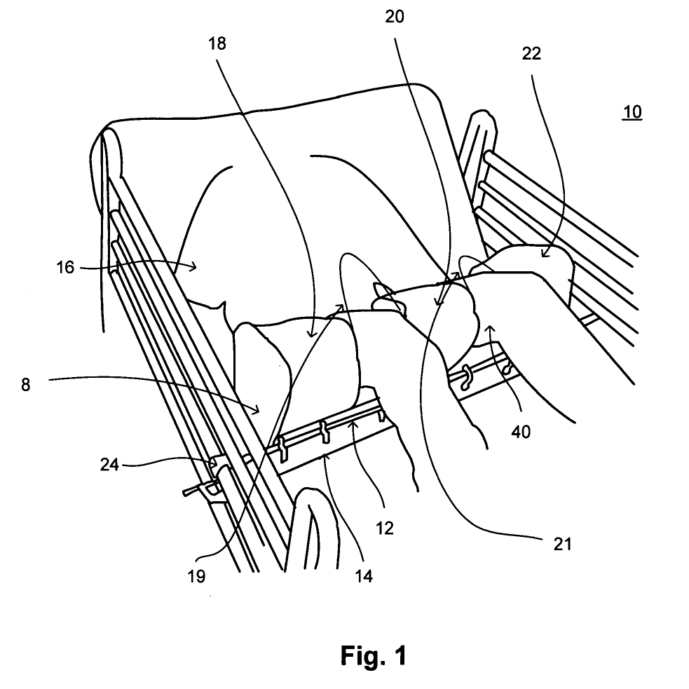

FIGS. 1 to 4 illustrate the stable position of a patient sitting in a hospital bed with the legs of the patient being secured in Arrangement 10 with Torso 16 at substantially right angles to Thigh 40. As would be readily recognized, the angle between the Torso 16 and the Thigh 40 is not required to be at about right angles, but may be adjusted in alternative embodiments. Arrangement 10 comprises a hospital bed and Support 8 with left part 18, middle part 20 and a right part 22 forming slots for receiving les or thighs. In the illustrative Arrangement 10, thigh 40 is secured between middle part 20 and right part 22.

Support 8 is shown as a pillow for convenience, but this is not intended to be a limitation. A preferred shape for Support 8 is E-shaped. However, other shapes, including opposed E-shapes are also possible although not as preferred. Further, additional slots, i.e., more than two slots, are possible in alternative embodiments.

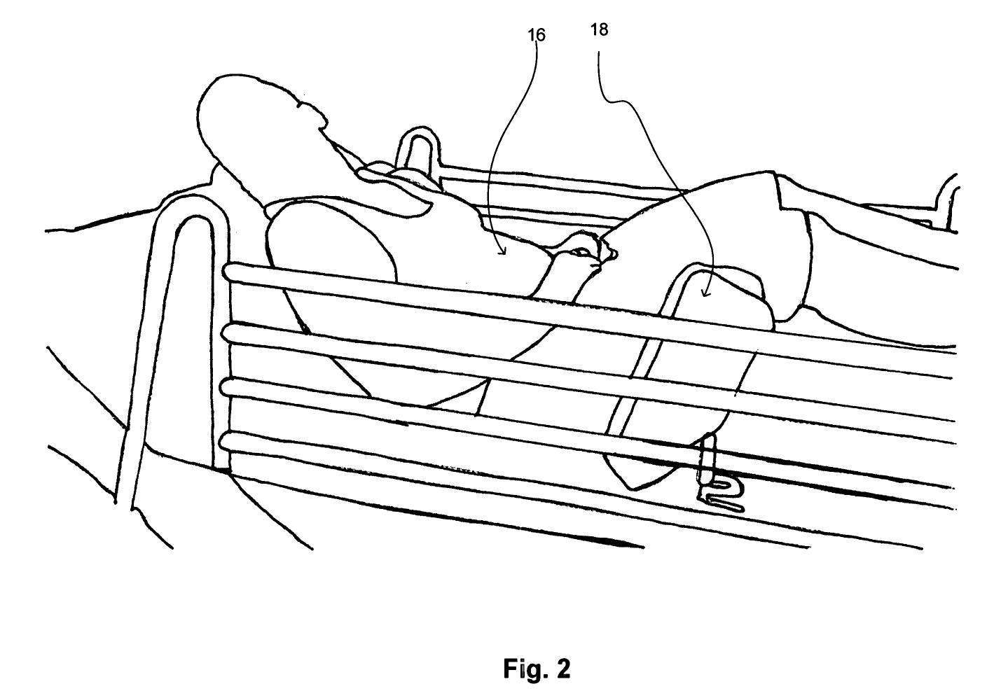

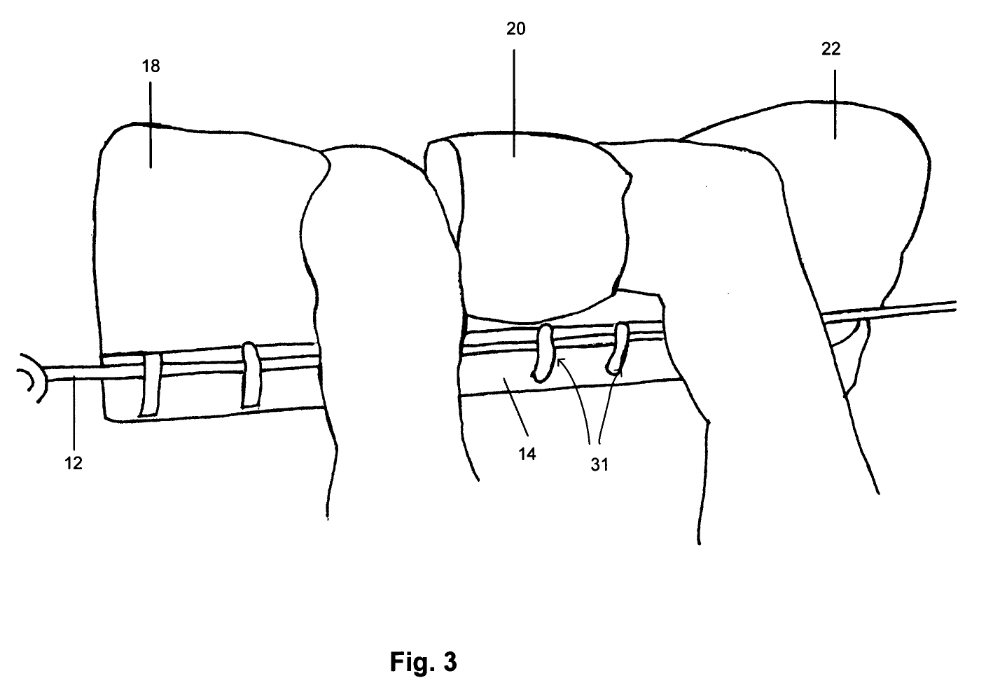

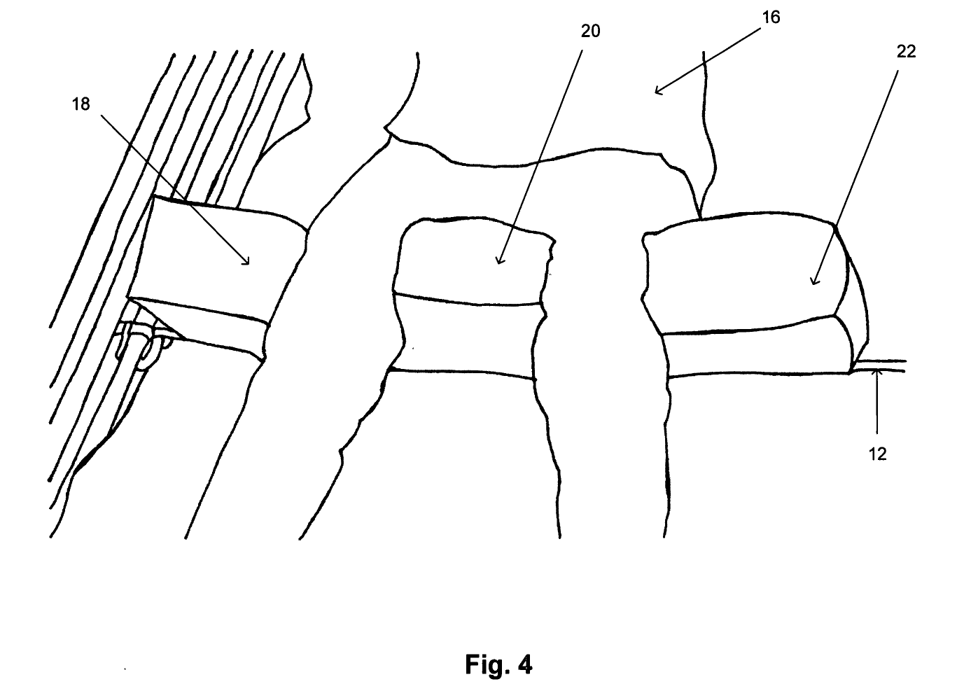

As shown in FIGS. 1-4, Support 8 has three sections 18, 20, 22 which define slots 19 and 21. Support 8 has support board 14 to provide rigidity in the illustrated embodiment, which is retained in place by support pole 12 with loops 31, as is shown in FIG. 3. Support pole 12 and board 14 prop up the sections 18, 20 and 22 and support a patient's legs upwards. Support pole 12 can slide along the rails of the bed to accommodate patients of varying heights/dimensions, as is seen in FIG. 1 (showing Clamp 24) and FIG. 2 and FIG. 4.

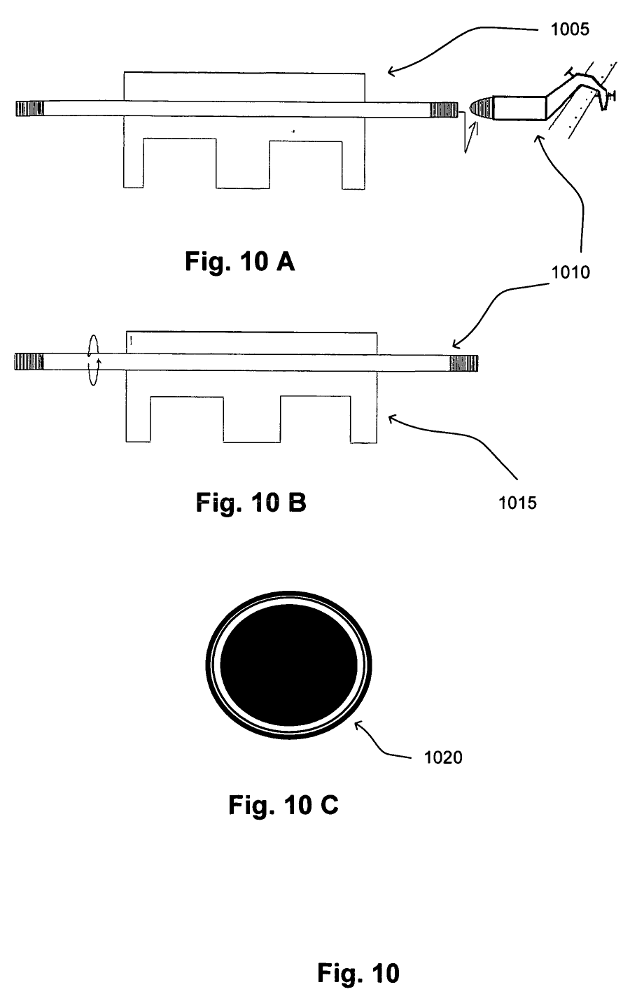

FIGS. 1-4, for instance, also illustrate, without limiting the equivalents thereof, a means affixed to the bed for propping up the support. The illustrated means comprise at least a clamp and a rod for affixing the support to a hospital bed. However, other clamps, joints, rods, composite rods, straight or shaped rods, hinges and the like may be employed with no loss of generality. Further, the propping up means as described may be adjusted as is shown later in FIG. 10. The illustrated adjustment using a handle and a screw mechanism is not intended to be exhaustive. In the interest of brevity and the many known methods for making such adjustments, including using powered drives, automated response systems, electronically controlled motors and the like are not described in excruciating detail. They are, however, considered to be within the scope of the equivalents thereof.

In addition, pivotable means are also described in FIGS. 1-4 and 10 in a like manner.

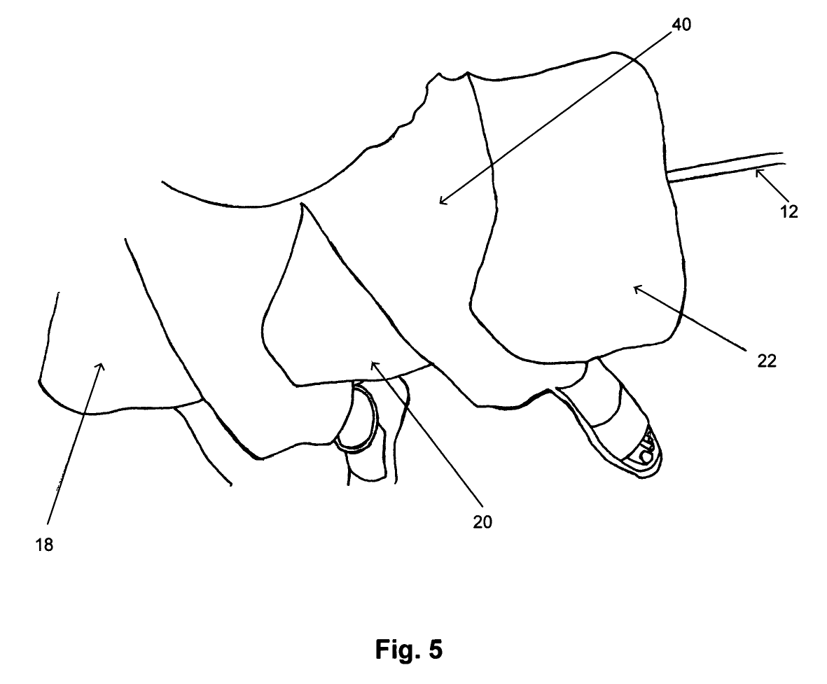

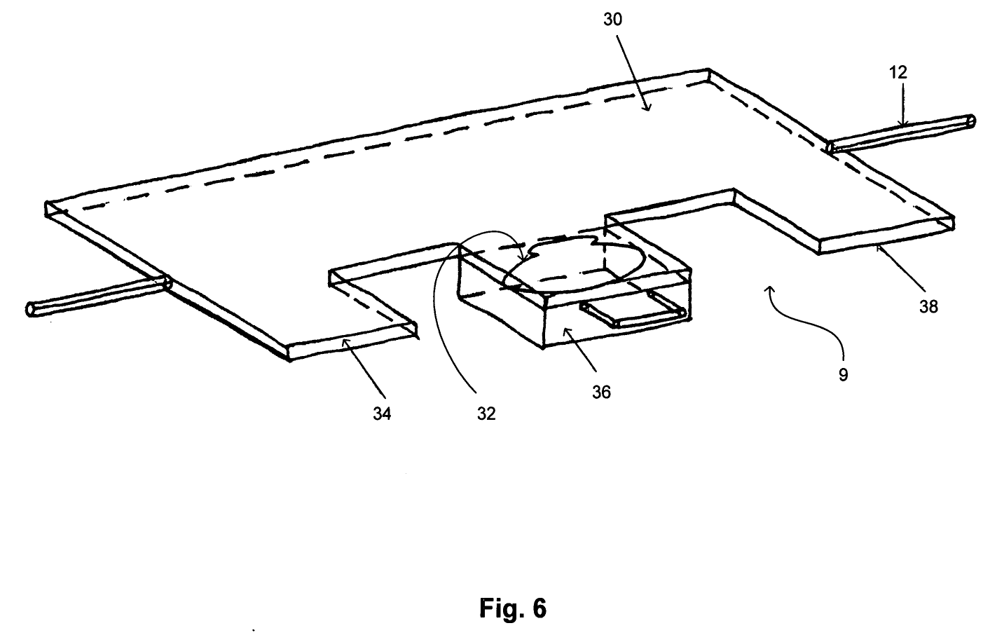

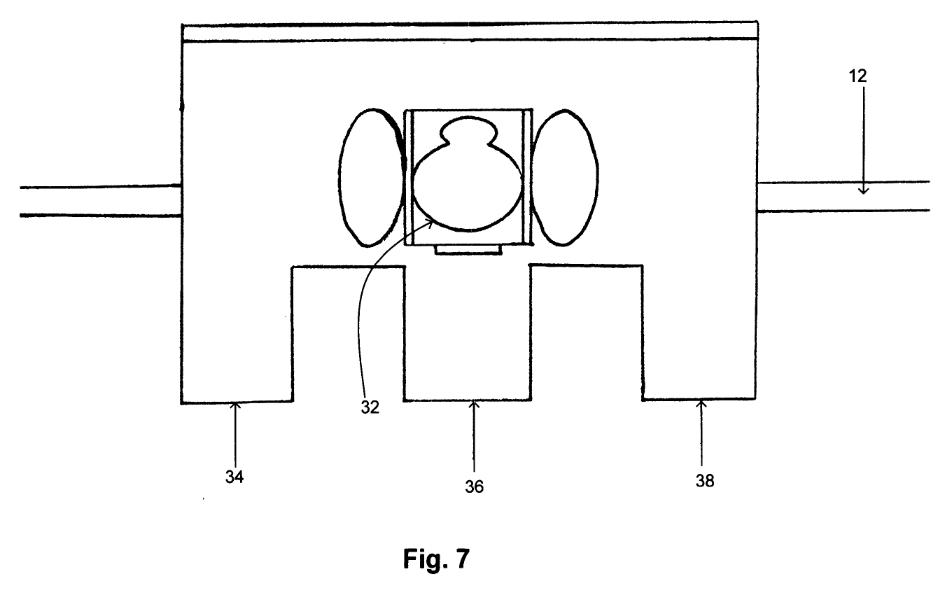

FIGS. 5, 6 and 7 illustrate an alternative embodiment of the invention which facilitates use of a bed pan or equivalent by patient 16 using Support 9, which also comprises three Side Panels 34, 36, 38 as in the case of Support 8. With the aid of the illustrative Support 9, Thigh 40 of the patient can be held by a Pivotable Board 30. Aperture 32 provides a space for a bed pan and to facilitate natural human functions. As with the first embodiment, Pivotable Board 30 can be moved to facilitate use by people with a wide range of heights and or dimensions. The legs or thighs of a patient or user fit between the openings defined by Side Panels 34, 38 and Central Panel 36.

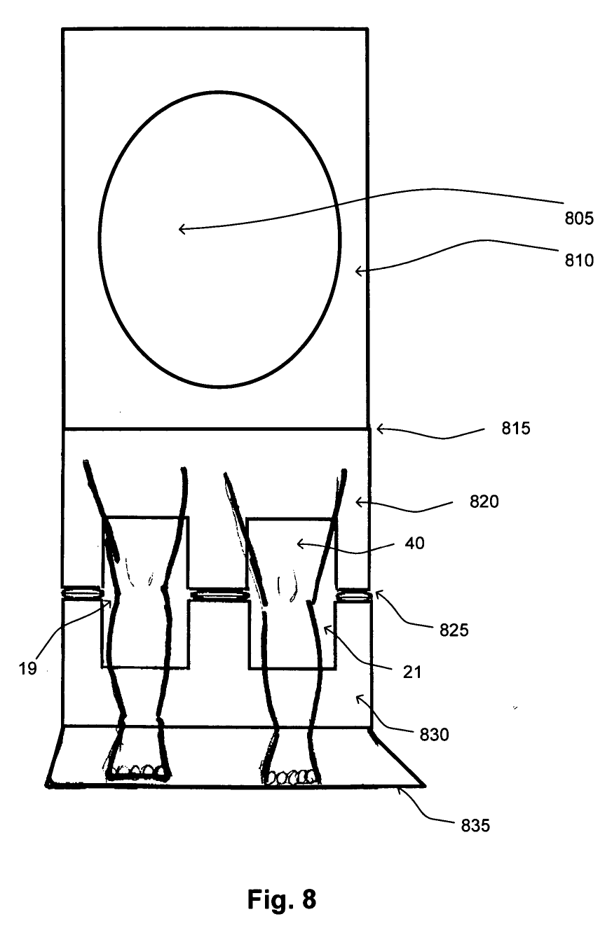

FIG. 8 illustrates the position of the legs in an alternative preferred embodiment such that the knees and lower thighs are slidable into slots formed in the manner described in FIGS. 1-7. Cushion 805 is affixed to Upper Panel 810 connected to Second Panel 820 via Hinge 815. Second Panel 820 is connected via Second Hinge 825 to Third Panel 830, which is followed by a Foot Panel 835.

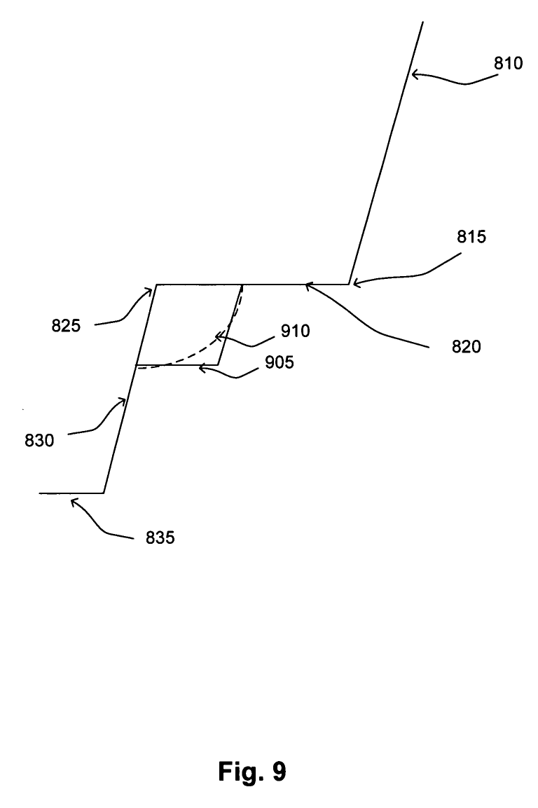

Slots 19 and 21 are formed by having corresponding portions foldaway in a direction opposite to that for the joint between Second Panel 820 and Third Panel 830. This is illustrated in a side view in the schematic FIG. 9. Folded-in First Portion 905 and alternative Folded-in Portion 910 (shown with broken lines) illustrate possible methods for forming slots 19 and 21.

FIG. 10 illustrates another approach for making a support, such as Support 8 or Support 9, by making a top part 1005 (FIG. 10A) and a bottom part 1015 (FIG. 10B) with a rod 1010 for affixing it to a hospital bed. The rod is shown with the optional handle in FIG. 10. Further, the rod may be a composite as is shown in FIG. 10C to increase the strength of the rod while keeping the cost and weight of the rod as low as possible.

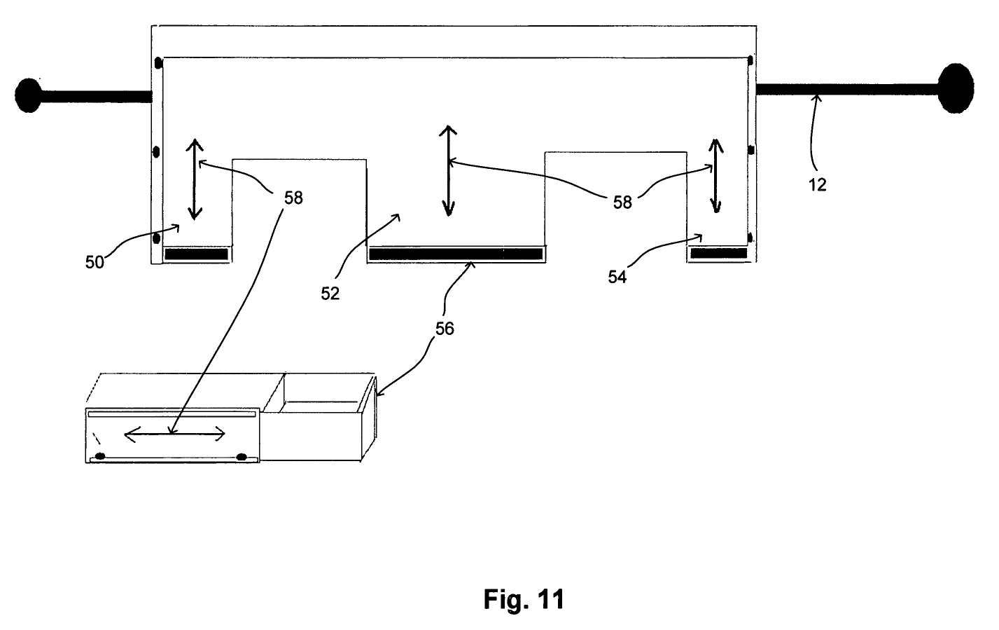

FIG. 11 shows another alternative construction for support, such as Support 8 or Support 9, to provide adjustable depth slots. Arrows 58 show possible adjustment in the depth of a slot formed by sides 50, 52 and 54 in the manner described earlier. A drawer like mechanism shown as 56 allows the length of an illustrative side 52 be changed. It should be noted that this is merely illustrative and not exhaustive and equivalents, including powered, hydraulic, automated and other similar known mechanisms can be employed with no loss of generality to provide for adjustability. Further, in alternative embodiments, adjustments in the width of the slots may be provided.

It should be noted that a method disclosed in accordance with the invention, allows preventing a patient in a bed from sliding by providing a support with a plurality of slots to receive at least one leg of a patient. The support with the plurality of slots preferably prevents the patient from sliding sideways or forward. Preferably, the support with the plurality of slots prevents accumulation of fluids in a leg of the patient by raising them comfortably. Moreover, advantageously a leg of the patient is supported by placing a thigh of the patient in a slot from the plurality of slots and at about right angles to a torso of the patient. This is, however, not a requirement for using the support or the claimed method. Preferably, at least one of slots does not encircle at least one leg of the patient, which makes it easy to place or remove the leg from the slot. Furthermore, the method comprises providing an adjustable depth for at least one of the plurality of slots to accommodate patients of different sizes and with different needs.

An optional opening in the support with a plurality of slots can be provided to receive waste products produced by the patient.

The invention is not limited to hospital beds and may be used in designing seats for handicapped individuals as well as infants and even designer furniture. The disclosed arrangement need not be merely utilitarian and may instead be modified to provide primarily a decorative effect although this possibility has not been emphasized in this disclosure.

The invention is described with reference to the attached figures and their accompanying description such that the scope of the invention is to be determined by reference the claims appended hereto. All of the references cited in this application are incorporated by reference.

I claim:

1. A support system for use with a hospital bed comprising:
a support having a pair of openings for the legs of a patient;
means affixed to the bed for propping up the support so as to maintain the legs of a patient at approximately right angles with respect to the patient's upper torso.

2. The support system of claim 1 further comprising means for adjusting the propping up means.

3. The support system of claim 1, wherein the support has one or more of a cushion, a shape contoured to complement a human body, and an opening for receiving waste.

4. The support system of claim 1 adapted for use with a hospital bed to assist a patient with natural functions comprising:
a substantially flat support having a plurality of slots for supporting one or more legs of the patient and further having central aperture to channel away waste products.

5. The support system of claim 4 further comprising:
pivotable means affixed to the sides of the substantially flat support for permitting the flat support to pivot so that the patient's legs may be placed at about right angles to an upper torso to approximate a sitting position.

6. An E-shaped support with a substantially rigid backing for providing support to one or more legs of a patient in a bed; wherein the E-shaped us affixable to the bed.

7. The E-shaped support of claim 6 is deployed to prevent the patient from sliding.

8. The E-shaped support of claim 6 is deployed with an additional support to grip at least one leg of the patient.

9. The E-shaped support of claim 6 deployed with a bed panel such that the bed panel may be pivoted to place a patient in a sitting position without unacceptable sliding, wherein the E-shaped support can pivot about at least one axis.

10. The E-shaped support of claim 6 further comprising an adjustable depth for at least one of the slots in the E-shaped support.

11. The E-shaped support of claim 6 as deployed in one or more of the set consisting of a hospital bed, an infant seat, and a reclining seat, a seat with an adjustable back such that the back may be fixed in a plurality of positions relative a horizontal portion of the seat with an adjustable back.

12. A method of preventing a patient in a bed from sliding by providing a support with a plurality of slots to receive at least one leg of a patient.

13. The method of claims 12, wherein the support with the plurality of slots prevents the patient from sliding sideways.

14. The method of claims 12, wherein the support with the plurality of slots prevents the patient from sliding forward.

15. The method of claims 12, wherein the support with the plurality of slots prevents accumulation of fluids in a leg of the patient.

16. The method of claims 12, wherein the one or more legs are supported by placing a thigh of the patient in a slot from the plurality of slots and at about right angles to a torso of the patient.

17. The method of claims 12, wherein at least one of slots in the plurality of slots does not encircle at least one leg of the patient.

18. The method of claims 12 further comprising the step of providing an adjustable depth for at least one of the plurality of slots.

19. The method of claims 12 further comprising the step of providing an opening in the support with a plurality of slots to receive waste products produced by the patient.

20. The method of claims 12 further comprising the step of deploying the support with a plurality of slots in one or more of the set consisting of a hospital bed, an infant seat, and a reclining seat, a seat with an adjustable back such that the back may be fixed in a plurality of positions relative a horizontal portion of the seat with an adjustable back.
